(19) United States
(12) Patent Application Publication
(10) Pub. No.: US 2007/0220481 A1
(43) Pub. Date: Sep. 20, 2007

(54) Limited source code regeneration based on model modification

(75) Inventors: Ronald K. Gabel, Copenhagen (DK); Christian Heide Damm, Hillerod (DK); Michael Svanholm Thomsen, Copenhagen (DK); Jorge Alberto Torres Huerta, Alsgarde (DK)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/384,591

(22) Filed: Mar. 20, 2006

(51) Int. Cl. G06F 9/44

(52) U.S. Cl. 717/106

(57) ABSTRACT

A model corresponds to a collection of source code files. A determination is made that a change has occurred to the model. A sub-set of the collection of source code files is updated or regenerated to reflect the change to the model.

### BACKGROUND

An application environment sometimes incorporates a process wherein source code is generated based on a corresponding model. Thus, for a given model element (e.g., a model element contained in a model file, in a database, in memory, etc.), related source code may be defined in one or more source code files. A substantial portion, if not the majority, of source code may be generated through a process that involves making reference to a corresponding model.

As the size and complexity of models increase, the initial creation of source code files upon loading, regardless of whether created previously, can become very slow and expensive in terms of processing resources. Further, it is often desirable that generated source code be recreated to reflect changes made in the model. Thus, source code files may be overwritten or recreated many times during the life of a corresponding model. The process of regenerating code files in response to model changes is also often slow and expensive. In some instances, all code files may be regenerated for each model change, including code files that are not affected by the change.

The discussion above is merely provided for general background information and is not intended for use as an aid in determining the scope of the claimed subject matter. Further, it should also be emphasized that the claimed subject matter is not limited to implementations that solve any or all of the disadvantages of any currently known systems noted in this section.

### SUMMARY

A model corresponds to a collection of source code files. A determination is made that a change has occurred to the model. A sub-set of the collection of source code files is updated or regenerated to reflect the change to the model.

This Summary is provided to introduce, in a simplified form, a selection of concepts that are further described below in the Detailed Description. This Summary is not intended to identify key features or essential features of the claimed subject matter, nor is it intended for use as an aid in determining the scope of the claimed subject matter.

### BRIEF DESCRIPTION OF THE DRAWINGS

FIG. 1 is a block diagram of one computing environment in which some embodiments may be practiced.

FIG. 2 is a schematic block diagram of a code-based application system.

FIG. 3 is a block flow diagram demonstrating a series of steps associated with regenerating source code.

FIGS. 4A and 4B are block flow diagrams demonstrating steps associated with selective regeneration of source code.

### DETAILED DESCRIPTION

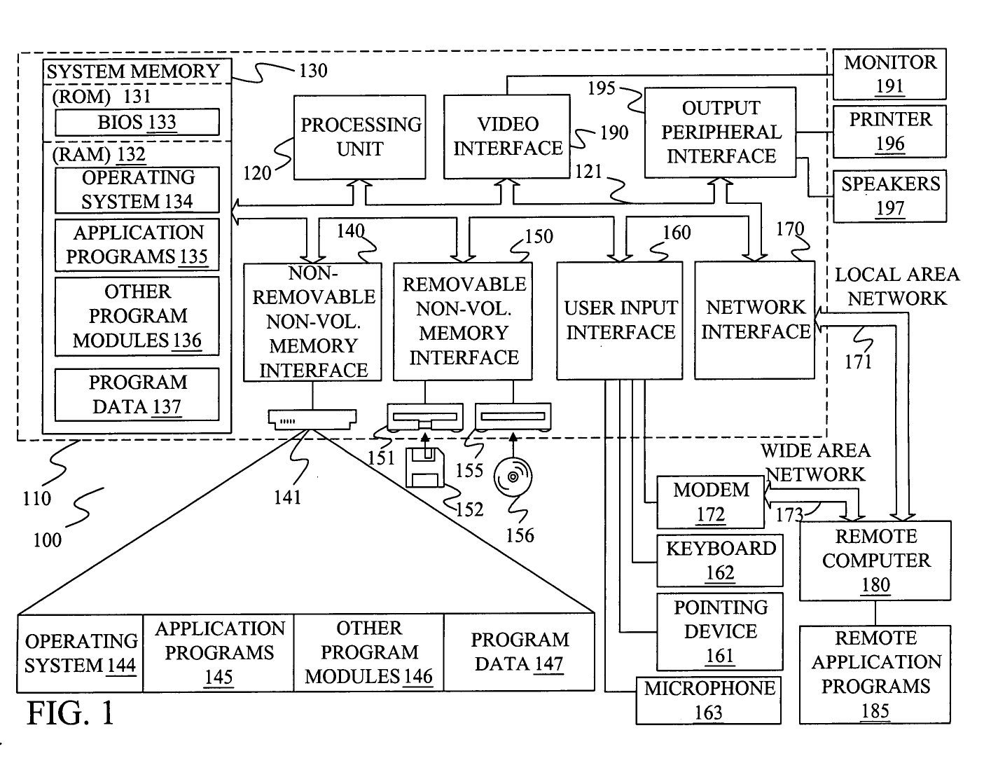

FIG. 1 illustrates an example of a suitable computing system environment 100 in which embodiments may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing some embodiments includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed-above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also Include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

It is sometimes desirable to regenerate source code to reflect changes to a corresponding model (e.g., changes such as when one or more model elements are added, changed, removed, etc.). It is almost always true that a given model change will impact a limited portion of the total source code (e.g., a limited set of the total number of source code files). Thus, at least for the purpose of avoiding unnecessary processing, it is desirable to respond to model changes by selectively regenerating a limited amount of source code.

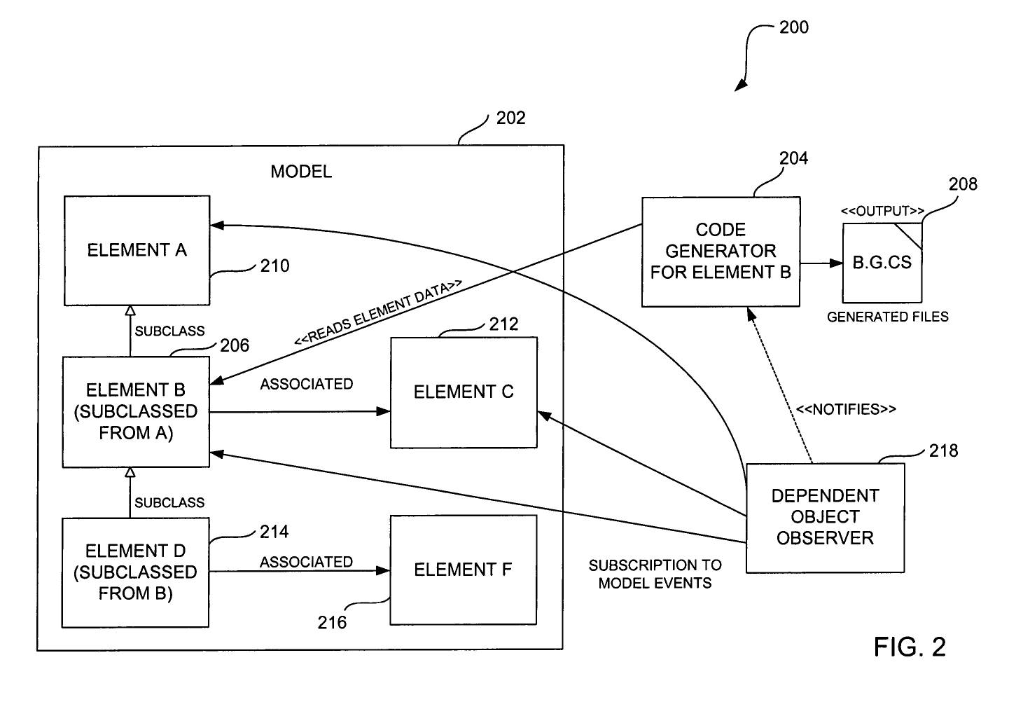

FIG. 2 is a schematic block diagram of a code-based application system 200. System 200 includes a model 202. A code generator 204 is illustratively configured to generate source code for a particular model element B. Model element B is identified in FIG. 2 as block 206. The generated source code is identified with reference numeral 208. Code 208 could be multiple source code files but is depicted in FIG. 2, for the purpose of simplifying the example, as a single source code file “B.g.cs”.

It is to be understood that system 200 is a simplified example intended only for the purpose of illustration. Actual systems are likely to be far more complex. For example, model 202 is likely to include many more model elements with many different relationships between elements. It is to be understood that additional code generators and related components are likely to be implemented for a other model elements in a manner that similarly reflects the functional relationship between code generator 204 and element B, which will now be described in greater detail.

Code generator 204 illustratively contains logic for generating B.g.cs based on 1) model element B; and 2) based on a subset of model elements directly and/or transitively referenced by model element B. In the context of the example depicted in FIG. 2, code generator 204 is configured to read information from model element A (block 210), model element B (block 206), and model element C (block 212). Code generator 204 is not configured to read information from model element D (block 214) or model element F (block 216), because model elements D and F are not needed to generate the code 208. The model elements A, B, and C are illustratively referred to as “dependent” because they are the particular model elements that generation of B.g.cs depends on.

Those skilled in the art will appreciate that the need to regenerate source code 208 arises in a variety of different circumstances. For example, with reference to FIG. 2, if the base class name in element A is changed to Z, the code file (B.g.cs) needs to be regenerated with this new base name (e.g., class b: Z). Or, if element C is renamed to Y and B has dependent methods, then the properties in element B's code file need to be updated (e.g., private C.Key becomes private Y.Key). These are just two examples of when updating might be desirable.

Source code generator 204 is illustratively equipped with access to a notification functionality that enables it to become aware when model element changes, that might be worthy of source code regeneration are made. In one embodiment, an observer 218 is affiliated with code generator 204 and configured to monitor changes to related dependent model elements. When a change that may be worthy of source code regeneration is detected, observer 218 communicates appropriate notification to code generator 204. Code generator 204 then reads the model as necessary to support regeneration of source code.

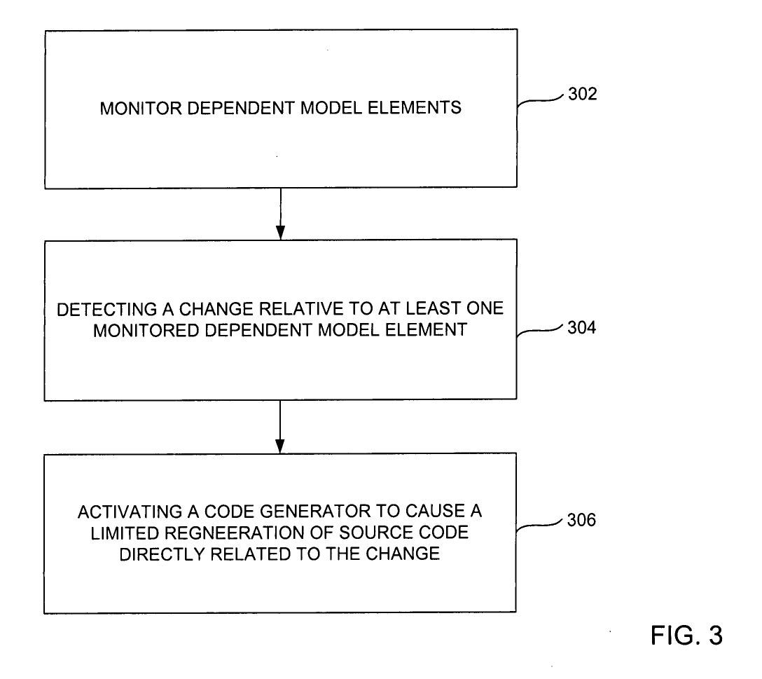

FIG. 3 is a block flow diagram demonstrating a series of steps associated with regenerating source code in a manner similar to that described in the context of system 200. In accordance with block 302, there is a monitoring of a set of dependent model elements. The set of dependent model elements might include a single element, or a single element plus relevantly associated additional elements.

In accordance with block 304, a change is detected relative to at least one monitored dependent model element (e.g., a change such as when one or more model elements are added, changed, removed, etc.). Finally, in accordance with block 306, a code generator is activated to cause a limited regeneration of source code directly related to the change. In one embodiment, only source code related to dependent model elements affected by the change is regenerated. In one embodiment, source code related to all monitored dependent model elements is regenerated, regardless of which of the dependent model elements is actually affected by the change.

Opportunities to improve processing efficiency do arise in other scenarios. For example, another scenario occurs during the initial creation of source code files upon initial loading of the model, regardless of whether the files have been created previously. Another scenario might occur when model changes made off-line are eventually brought on-line. In at least both of these cases, the source code may be outdated relative to the model. It would be desirable to update the source code without total regeneration. It would be desirable to exclude regeneration of many source code files that are not impacted by model element changes.

In accordance with one embodiment, after dependent objects have been enumerated for a given code generator, the code generator can be configured to initiate an update of the corresponding source code in response to a trigger other than a change notification received from a model element observer. Examples of alternate triggers will now be described.

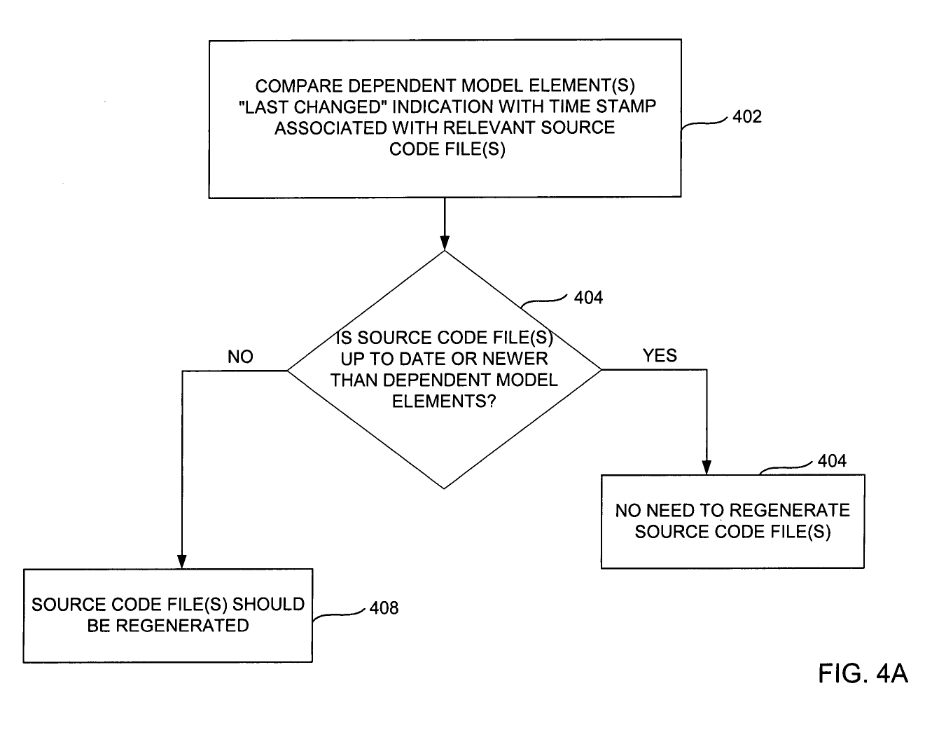

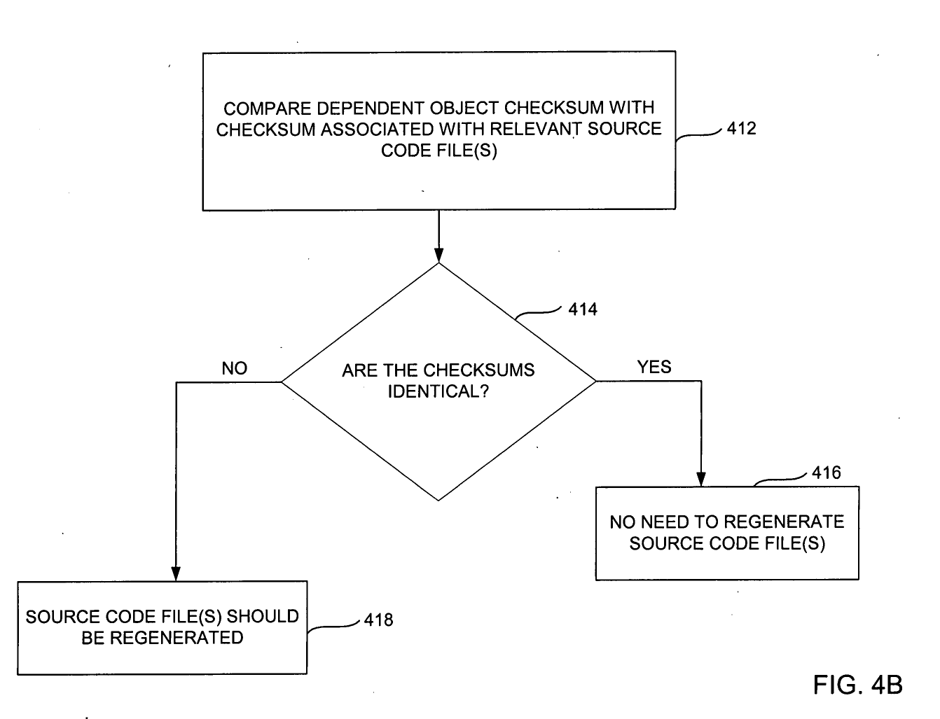

FIG. 4A is a block flow diagram demonstrating steps associated with a selective regeneration of source code. The illustrated process assumes that there is a set of dependent elements that are associated with a code generator. One or more of these dependent elements includes an indication of when last changes occurred (e.g., a timestamp). In accordance with block 402, the indication of when last changes occurred is compared to a time stamp associated with one or more relevant source code files. As is indicated by block 404, a determination is made as to whether the source code is up to date or newer than the dependent model elements. If so, then, as is indicated by block 406, no regeneration of source code files is necessary. If not, then, as is indicated by block 408, the code generator for the dependent model elements will initiate regeneration of corresponding source code.

Thus, in one embodiment, assuming model elements contain a “last changed” indication, the code generator illustratively compares the indication for its dependent objects with the time stamp for the corresponding source code (e.g., B.g.cs). If the source code is newer, then there is no need to regenerate the source code. Otherwise, the code is regenerated.

It should be noted that the scope of the present invention is not limited to a timestamp implementation. For example, a checksum can instead be calculated from dependent objects and compared with a checksum that is stored in a file next to the source code or directly within the source code. The checksum implementation could be desirable to avoid inconsistencies in timestamps caused, for example, by moving model elements and files between machines whose clocks are not synchronized.

FIG. 4B is a block flow diagram demonstrating steps associated with a selective regeneration of source code in accordance with a checksum implementation. In accordance with block 412, a check sum associated with one or more dependent model elements is compared to a checksum associated with one or more relevant source code files. As is indicated by block 414, a determination is made as to whether the checksums are consistent or identical with one another. If so, then, as is indicated by block 416, no regeneration of source code files is necessary. If not, however, then, as is indicated by block 418, the code generator for the dependent model elements will initiate regeneration of corresponding source code.

In accordance with one embodiment, for a given code generator, after source code is brought up to date with corresponding dependent model elements, monitoring of the elements is then passed to a listener object (i.e., a dependent object observer) that subscribes to add/change/remove/etc. events. If one or more dependent objects are changed, the listener object notifies the code generator about it, and the code generator regenerates source code accordingly (e.g., regenerates B.g.cs.). In one embodiment, when even one dependent object is changed, the entire corresponding set of dependent objects is recalculated because the entire set may have also changed.

The described system can be configured to provide customized support for a transaction-based modeling framework in which multiple model elements can be changed (e.g., added/changed/removed) in one transaction. For example, the system can be configured such that the listener object (i.e., the dependent object observer) is made aware of multiple changes to dependent objects arising from a single user or system action. The listener object can be configured to respond to these circumstances by aggregating the events. When the actual transaction is completed, a single event is raised to the code generator. This avoids unnecessary intermediate regeneration.

Those skilled in the art will appreciate that the concepts of the present invention are easily extensible. For example, the so-called “model elements” described herein are not limited to being in-memory elements loaded from a file. For example, they could alternatively be rows in a database or something similar. Alternatively, a model element might be an image, a document, or any other representation of information. Further, the generated files described herein are not limited to being source code. Nor are they even limited to being files at all. They also could be rows in a database or something similar.

Further, it should be emphasized that the changes that occur to model elements and trigger source code regeneration do not have to occur in an on-line or especially dynamic environment. For example, in one embodiment, changes to the model occur offline. When a connection is re-established, the changes that occurred offline are utilized to update the model, thereby triggering source code regeneration in accordance with the systems and methods described herein.

Still further, a source code file may contain multiple parts, for example, a generated part and a user-controlled part. Those skilled in the art will appreciate that it is within the scope of the present invention to facilitate selective automated updating or regeneration of all or less than all of the parts of a given source code file (e.g., regeneration may be limited to only the generated part or only the user-controlled part). What is referred to singularly herein as a source code file (e.g., “a” or “the” source code file) may actually be a set of related files, all or some of which might be configured for selective automatic regeneration.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for updating source code when changes have been made to a corresponding model, the method comprising:
determining that a change has occurred to the model, wherein the model corresponds to a collection of source code files; and
updating a sub-set of the collection of source code files to reflect the change to the model.

2. The method of claim 1, wherein updating further comprises updating less than all source code files included in said collection of source code files.

3. The method of claim 1, wherein determining comprises:
monitoring a sub-set of model elements in the model; and
detecting a change in at least one model element in the sub-set.

4. The method of claim 3, wherein monitoring a sub-set comprises implementing an observer object to monitor when a model element in the sub-set is added, changed or removed.

5. The method of claim 4, wherein updating further comprises activating a code generator in response to a signal received from the observer object.

6. The method of claim 5, wherein activating a code generator comprises activating a code generator

7. The method of claim 1, wherein determining comprises comparing update timestamps associated with the model and the sub-set of the collection of source code files.

8. The method of claim 7, wherein, to the extent that comparing involves comparing update timestamps associated with the model, comparing more specifically comprises comparing update timestamps associated with a sub-set of model elements in the model.

9. The method of claim 1, wherein determining comprises comparing checksums associated with the model and the sub-set of the collection of source code files.

10. The method of claim 9, wherein, to the extent that comparing involves comparing a checksum associated with the model, comparing more specifically comprises comparing a checksum associated with a sub-set of model elements in the model.

11. The method of claim 1, wherein determining further comprises determining that an offline change has occurred to the model.

12. A system for updating a limited quantity of source code when changes have been made to a corresponding model, the system comprising:
a model comprising a collection of model elements;
a sub-set of model elements that is less than all of the model elements in said collection;
a collection of source code related to the sub-set of model elements;
a code generator configured to change the collection of source code based on changes made to the sub-set of model elements.

13. The system of claim 12, further comprising an object observer configured to monitor the sub-set of model elements and signal the code generator when a change has been detected.

14. The system of claim 12, further comprising a second code generator configured to change a second collection of source code based on changes made to a second sub-set of model elements, the second sub-set of model elements being part of the same model.

15. The system of claim 12, wherein the code generator is configured to regenerate the collection of source code based on changes made to the sub-set of model elements.

16. The system of claim 12, wherein the sub-set of model elements comprises a set of dependent model elements.

17. The system of claim 12, wherein the sub-set of model elements comprises a single model element along with related dependent model elements.

18. The system of claim 12, wherein the code generator configured to change the collection of source code when a model element in the sub-set of model elements is added, changed or removed.

19. A computer-implemented method for updating a limited quantity of source code when changes have been made to a corresponding model, the method comprising:
determining that a collection of source code does not reflect a change that has been made to a corresponding one or more model elements included in a model; and
updating the corresponding one or more model elements without totally updating the model.

20. The method of claim 19, wherein determining comprises implementing an observer object to monitor for changes to the corresponding one or more model elements.
